(19) United States
(12) Patent Application Publication
(10) Pub. No.: US 2024/0283645 A1
(43) Pub. Date: Aug. 22, 2024

(54) DATA SECURITY

(71) Applicant: ZIRCON GLOBAL TECHNOLOGIES, Reno, NV (US)

(72) Inventors: Adam Lavine, Reno, NV (US); Shingo Lavine, Reno, NV (US); Tanuj Soni, Indore (IN)

(21) Appl. No.: 18/172,235

(22) Filed: Feb. 21, 2023

(51) Int. Cl. H04L 9/14; H04L 9/08

(52) U.S. Cl. CPC H04L 9/14; H04L 9/0825; H04L 9/0861

(57) ABSTRACT

A method of securing data. The method may include obtaining plaintext to be encrypted and multiple inputs and generating multiple input combinations by combining the multiple inputs. The method may also include using each of the multiple input combinations to generate one first encryption key such that multiple first encryption keys are generated and obtaining multiple second encryption key pairs, each second key pair including a corresponding private key and public key. The method may further include encrypting each of the private keys with a different one of the multiple first encryption keys to generate multiple encrypted private keys and encrypting the plaintext using each of the public keys to generate multiple ciphertexts, each of the multiple ciphertexts being the plaintext as encrypted by a different one of the public keys.

### FIELD

The embodiments discussed herein are related to data security.

### BACKGROUND

With the explosion of data stored in servers throughout the world, data security continues to grow in importance. While security protocols exist to properly protect data, the security protocols are often only as good as the passwords used by the security protocols to access the data. If the passwords are simple or easily accessible, then the data is not protected even if the security protocols used are sufficient to secure the data.

The subject matter claimed herein is not limited to embodiments that solve any disadvantages or that operate only in environments such as those described above. Rather, this background is only provided to illustrate one example technology area where some embodiments described herein may be practiced.

### SUMMARY

A method of securing data. The method may include obtaining plaintext to be encrypted and multiple inputs and generating multiple input combinations by combining the multiple inputs. The method may also include using each of the multiple input combinations to generate one first encryption key such that multiple first encryption keys are generated and obtaining multiple second encryption key pairs, each second key pair including a corresponding private key and public key. The method may further include encrypting each of the private keys with a different one of the multiple first encryption keys to generate multiple encrypted private keys and encrypting the plaintext using each of the public keys to generate multiple ciphertexts, each of the multiple ciphertexts being the plaintext as encrypted by a different one of the public keys.

### BRIEF DESCRIPTION OF THE DRAWINGS

Example embodiments will be described and explained with additional specificity and detail through the use of the accompanying drawings in which:

FIG. 1 illustrates an example environment for securing data;

FIG. 2a illustrates example of operations for plaintext encryption;

FIG. 2b illustrates example of operations for private key encryption;

FIG. 2c illustrates example operations for plaintext decryption;

FIGS. 3a, 3b, and 3c illustrate example operations to secure data;

FIG. 4 illustrates a flowchart of an example method of securing data;

FIG. 5 illustrates a flowchart of another example method of securing data; and

FIG. 6 illustrates an example system that may be used to secure data.

### DESCRIPTION OF EMBODIMENTS

Data security is a leading concern for many people. Due to the rise of the Internet and digital networks, much, if not all, of society's personal and financial information is stored in servers throughout the world. As a result, this private information is subject to be stolen. Data security protocols exist to help reduce the likelihood of private information being stolen. However, data security protocols typically rely on plaintext phrases, e.g., passwords, to allow a user access to the private information protected by the security protocols. These plaintext phrases may be the weak link in security protocols as the plaintext phrases may be stolen or forgotten.

Alternately or additionally, the security of plaintext phrases may be important in other technologies such as blockchain technologies. Currently, some blockchain technologies use plaintext phrases, sometimes referred to as mnemonic phrases, to generate addresses and private keys that may be used with blockchain technologies. For example, for a cryptocurrency, a mnemonic phrase may be used to create a wallet that includes the private keys to identify the ownership of the particular coins of the cryptocurrency. If the mnemonic phrase is stolen, then the particular coins of the cryptocurrency associated with the wallet may also be stolen leading to significant losses. For example, according to Blockchain analytics firm Chainalysis, over $5 billion dollars in assets were hacked in calendar years 2021 and 2022 due to security and technical exploits.

Some embodiments described in this disclosure provide a method and/or system to secure plaintext phrases. The method and/or system secures a plaintext phrase using a combination of security protocols. A plaintext phrase may be secured by encrypting the plaintext phrase using a first encryption algorithm. A private key of the first encryption algorithm used to decrypt the encrypted plaintext phrase may be encrypted using a second encryption algorithm. The key for the second encryption algorithm may be based on a combination of inputs, such as answers to questions, instead of a single password that may be easily forgotten or lost.

The use of plaintext phrases, such as mnemonic phrases over varying lengths from 6, 12, 18, 24, 30, 36 or more words, to generate private keys that may be used with blockchain technologies unlocks a broad spectrum of practical applications for users to control their own crypto assets. The private keys may be used to broadcast and sign blockchain transactions across decentralized or “Defi” Level 1 networks such as Ethereum, Avalanche, or Binance Chain as well as Level 2 networks such as Optimism, Arbitrum or Polygon. For example, a user may search for the best prices across multiple decentralized exchanges or protocols such as SushiSwap, Pancake Swap or Uniswap, for one or more crypto currencies. Based on search, the user may select one or more exchanges or protocols and broadcast a trade to those exchanges. By having a private key associated with the wallet of a user, the user may break a single trade into multiple parts. For example, the user may send 20 percent of a trade to SushiSwap, 30 percent of the trade to Pancake Swap and 50 percent of the trade to Uniswap. The user having a unique private key allows the user to perform this functionality more easily.

In some embodiments, users may also set up formulas for accessing Defi liquidity pools for crypto-based yield or find other formulas for investing. For example, a user may decide to invest funds 50 percent in a Lending and Borrowing Pool and 50 percent in a Stable Pool. Inside of the Lending and Borrowing Pool, the user may choose several crypto pairs, creating and naming their own unique formula or recipe for seeking a return on those crypto pairs. In these and other embodiments, the formula may be published and enable another user to see and copy that formula, either using the formula verbatim or adjusting the formula and republishing it as a new yield formula. In some embodiments, the formula may be created or programmed by a user with little or no programming experience. For example, the user may interact with a user interface to provide a desired strategy. For example, the user may interact with the user interface using standard interface protocols, such as, typing into a text box, selecting, or unselecting information, radio buttons, drop siren, or the like. The desired strategy may be used to form formula for investing. Based on the formula, a custom smart contact may be automatically generated and, with or without confirmation from a user, executed and transmitted to the blockchain. Having the user interface provide assistance in creating the formula is advantageous because users with limited software programming and/or defi protocol experience may instruct a system to create and execute customized smart contracts for complicated strategies that were previously available only to highly trained experts or had to be executed in multiple steps leading to inefficient and/or expensive consequences.

To achieve creation of formulas, a user might segregate different trading “areas” within an application, such as a trading area for a Level 1 Blockchain such as Ethereum, Avalanche and Binance Chain and another trading area for a Level 2 Blockchain such as Optimism, Arbitrumor Polygon. However, all of these areas may be secured by the same private keys from the same plaintext phrases. All the areas being secured by the same private keys may enable the user to sign and broadcast transactions using a single set of private keys that are completely under control of the user where the plaintext phrases used to generate the private keys and/or the private keys themselves may be sharded and backed up in a safe and efficient manner as described in this disclosure.

In some embodiments, a further benefit of using private keys is that some or all transactions, such as swaps, yield formulas, or other, may be aggregated into a portfolio view similar to a modern brokerage showing gains and losses. All the transactions may be aggregated into a portfolio view because the private keys are a unique cryptographic address that may control one or more specific blockchain addresses. As a result, search may be run on all addresses related to the cryptographic address of the private keys and generate a pie chart or similar display of the assets held in that cryptographic address. Furthermore, a portfolio view, such as used for stock market holdings may be implemented. For example, a gain/loss statements may be generated by estimating the current value of all cryptographic assets secured by the private keys and comparing them against the estimated value when the initial transaction occurred.

In these and other embodiments, a gain/loss statements may be converted into a stable coin currency pegged to the U.S. dollar such as USDC or may be generated pegged to the value of a crypto currency such as Ethereum or Bitcoin or a Level 2 cryptocurrency such as Avalanche, Polygon or Optimism. These gain/loss statements may further be converted into a local fiat currency such as the Euro, Yen, Rupee, or any other fiat currency issued by any government agency. These gain/loss statements may help to give users control over their crypto assets as well as enable the users to stay better compliant with any tax obligations generated by crypto gains or losses.

Alternately or additionally, private keys as described may not limited to chains with DeFi functionality. Private keys may be applied to any BIP44 compatible blockchain network. For example, plaintext may be used to store BIP32 hierarchical deterministic seeds which secure assets spanning across multiple blockchains and cryptocurrencies. Plaintext may also be used to generate keys, passphrases or other secrets which need to be backed up and restored in a decentralized manner. Furthermore, custodians or trustees may use the methods and/or systems described in this disclosure to create decentralized clearinghouses without the use of threshold signatures and decentralized backup and/or approval structures without any backup participant holding a full private key.

Alternately or additionally, to further secure the plaintext phrase, before encrypting the plaintext phrase, the plaintext phrase may be divided into multiple parts. Each of the multiple parts of the plaintext phrase may be encrypted using the first encryption algorithm. After encryption, the multiple parts may be stored on separate systems or devices.

In some embodiments, to access the plaintext phrase, a user may provide answers to the multiple questions. Based on the answers to the multiple questions, the combination of inputs may be used to generate the key for the second encryption algorithm that may be used to encrypt and decrypt the private key of the first encryption algorithm. The decrypted private key may be used to access the multiple parts of the plaintext phrase and decrypt the parts of the plaintext phrase. In these and other embodiments, other security protocols may also be implemented such as a waiting time and/or completion of other verification processes before some or all of the encrypted parts of the plaintext phrase are provided for decryption.

In some embodiments, the method and/or system described in this disclosure may also provide a mechanism to reduce the chance that a user is unable to access the plaintext phrase after it is encrypted. In some circumstances, a user may forget an answer to one or more of the questions. To assist in these situations and to help to ensure that a user is able to access the plaintext phrase after it is encrypted, the combination of inputs used to generate the key for the second encryption algorithm may be based on a subset of the initial inputs provided by a user. For example, five questions may be asked, and five answers may be obtained from the user. The combination of inputs used to generate the key for the second encryption algorithm may be based on a subset of the five answers, such as three of the five answers. As a result, when a user desires to access the plaintext phrase, answering correctly any three of the five questions may allow the system to generate the combination of inputs used to generate the key for the second encryption algorithm and thereby obtain the plaintext phrase after it is encrypted.

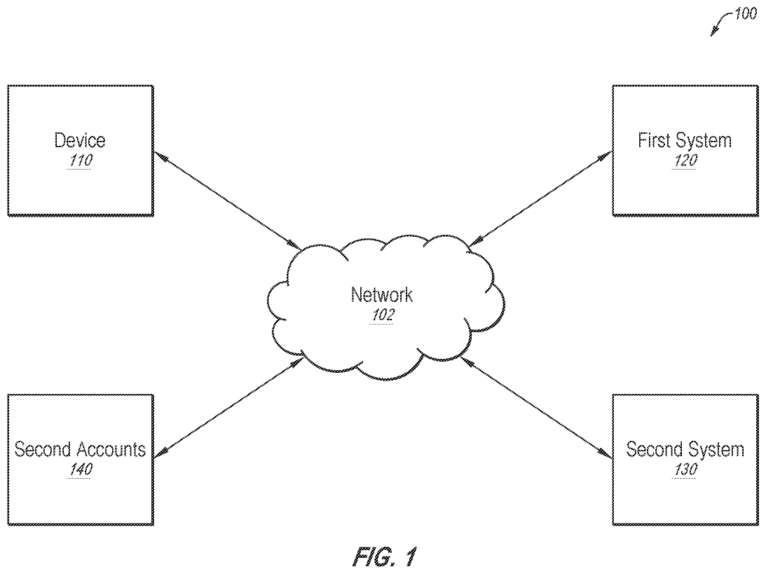

Turning to the figures, FIG. 1 illustrates an example environment 100 for securing data. The environment 100 may be arranged in accordance with at least one embodiment described in the present disclosure. The environment 100 may include a network 102, a device 110, a first system 120, a second system 130, and secondary accounts 140.

The network 102 may be configured to communicatively couple the device 110, the first system 120, the second system 130, and/or the secondary accounts 140. In some embodiments, the network 102 may be any network or configuration of networks configured to send and receive communications between systems and devices. In some embodiments, the network 102 may include a wired network, an optical network, and/or a wireless network, and may have numerous different configurations, including multiple different types of networks, network connections, and protocols to communicatively couple devices and systems in the environment 100.

In some embodiments, the device 110 may be configured to interface with a user. In these and other embodiments, the device 110 may present information to the user and obtain inputs from the user. In some embodiments, the device 110 may include or be any electronic or digital computing device. For example, the device 110 may include a desktop computer, a laptop computer, a smartphone, a mobile phone, a tablet computer, or any other computing device that may be used to perform operations as described in this disclosure. In these and other embodiments, the device 110 may include memory and at least one processor, which are configured to perform operations as described in this disclosure, among other operations. For example, the device 110 may include computer-readable instructions that are configured to be executed by the device 110 to perform operations described in this disclosure.

In some embodiments, the first system 120 and the second system 130 may include any configuration of hardware, such as processors, servers, and database servers that are networked together and configured to perform a task. For example, each of the first system 120 and the second system 130 may include one or multiple computing systems, such as multiple servers that each include memory and at least one processor, which are configured to perform operations as described in this disclosure, among other operations. For example, each of the first system 120 and the second system 130 may include computer-readable instructions that are configured to be executed to perform operations described in this disclosure.

In some embodiments, the device 110 may be configured to obtain plaintext to be secured. In these and other embodiments, the plaintext may be obtained by the device 110 via a user of the device 110. Alternately or additionally, the plaintext may be obtained by the device 110 generating the plaintext using an application running on the device 110. Alternately or additionally, the plaintext may be obtained by the device 110 from another system, such as the first system 120, the second system 130, or some other system. As an example, the plaintext may be a mnemonic phrases used in a blockchain technology. Alternately or additionally, the plaintext may be another password phrase or other phrase that may be used to store or access sensitive data.

In some embodiments, the device 110 may encrypt the plaintext using a public-key encryption algorithm to generate a ciphertext. In these and other embodiments, the public-key encryption algorithm may include a key pair that includes a public key and a private key. The public key may be used for encryption and the corresponding private key may be used for decryption. Examples of public-key encryption algorithm include RSA, YAK, Cramer-Shoup, and ElGamal, among others.

In some embodiments, the device 110 may divide the plaintext into parts, referred to as shards, before encrypting the plaintext using the public-key encryption algorithm. For example, the plaintext may be divided into multiple different shards such that to reconstruct the plaintext all of the shards may be used, and reconstruction of the plaintext may not be possible without all of the shards. In these and other embodiments, the plaintext may be divided into any number of shards. Alternately or additionally, the plaintext may be divided into multiple different shards using an algorithm so that the plaintext may be reconstructed without all of the plaintext shards. In these and other embodiments, the number of shards to reconstruct the plaintext may be based on a threshold number used by the algorithm when dividing the plaintext into the shards. In these and other embodiments, the threshold number may be any number equal to or less than the number of shards into which the plaintext is divided. An example algorithm to divide plaintext may include Shamir's secret sharing algorithm. In these and other embodiments, each of the shards may not include sufficient information to reconstruct the plaintext without other of the shards. In these and other embodiments, in response to the plaintext being divided into shards, each of the shards may be encrypted using the public-key encryption algorithm to generate multiple ciphertexts.

In some embodiments, the device 110 may obtain one or more inputs from the user. In some embodiments, the inputs may be answers to questions and/or requests presented by the device 110. Alternately or additionally, the inputs may be text, sounds, images, or other inputs that the user may provide in response to a request from the device 110. For example, the inputs may be one or more biometric signatures of the user. For example, the inputs may include one or more of a face image, fingerprint image, and iris image. In these and other embodiments, when there are multiple inputs, the device 110 may generate a combination of the inputs. For example, the inputs may include the words “fish,” “truck,” and “blue” and the combination of the inputs may be “fishtruckblue.” As another example, the inputs may be a sound, a face image, and an iris image. In these and other embodiments, vectors of each of the sound, the face image, and the iris images may be combined. Alternately or additionally, hashes of each of the sound, the face image, and the iris images may be combined. As another example, the inputs may be a face image, an answer to a question and/or requests, and an image of another object. In these and other embodiments, vectors, hashes, or some other representation of each of the face image, the answer to a question and/or requests, and the image of the other object may be combined.

In some embodiments, the device 110 may use the single input or combination of inputs as a seed to generate a key of a second encryption scheme. The key may be generated using a key derivation function, such as PBKDF1 or PBKDF2, among other password based key derivation functions. In these and other embodiments, the device 110 may generate the key, which may be a hash of the single input or combination of inputs. In addition to generating the key, the device 110 may generate an identifier of the key. The identifier may uniquely identify the key. For example, the identifier may be a checksum of the key.

In some embodiments, the device 110 may use the key to encrypt the private key of the public-key encryption algorithm using a second encryption algorithm. In these and other embodiments, the second encryption algorithm may be a symmetric type of encryption algorithm. For example, the second encryption algorithm may be the advanced encryption standard (AES) encryption algorithm or other algorithms such as Twofish, Serpent, Camellia, Salsa20, ChaCha20, Blowfish, CAST5, Kuznyechik, RC4, data Encryption Standard (DES), 3DES, Skipjack, Safer, and International Data Encryption Algorithm (IDEA), among other symmetric key algorithms.

In some embodiments, after encryption of the plaintext and encryption of the private key, the device 110 may direct the ciphertext and the encrypted private keys to one or both of the first system 120 and the second system 130. Alternately or additionally, the device 110 may maintain one or both of the ciphertext and the encrypted private keys at the device.

In some embodiments, in response to a request to obtain the plaintext, the device 110 may present a request to a user to obtain the one or more inputs used to generate the key for the second encryption algorithm. For example, the device 110 may present questions and obtain responses from the user as the inputs. For example, the responses may be text, images, sounds, or other inputs. The device 110 may use the inputs to generate a key to decrypt the encrypted private key. After decrypting the encrypted private key, the private key may be used to decrypt the ciphertexts to obtain the plaintext. Alternately or additionally, in response to the ciphertext being stored in another device and/or system, the device 110 may use the private key to obtain the ciphertext from the other device and/or system. For example, the device 110 may sign a message using the private key. In response to sending the signed message, the device 110 may obtain the ciphertext and decrypt the ciphertext using the private key. In this manner, the device 110 may obtain the plaintext. In these and other embodiments, when there are multiple ciphertexts from the encryption of multiple shards of the plaintext, after decrypting the shards, the shards may be combined to generate the plaintext.

In some embodiments, the device 110 may be configured to use multiple different combinations of inputs to encrypt and decrypt the plaintext. For example, the device 110 may obtain multiple different inputs. Using the multiple different inputs, the device 110 may generate multiple different input combinations. In some embodiments, the multiple input combinations may each include all of the inputs obtained by the device 110 or a subset of the inputs obtained by the device 110. For example, when there are four inputs, each of the input combinations may include all four inputs arranged in different orders. Alternately or additionally, each of the input combinations may include two or three inputs of the four inputs. Alternately or additionally, the multiple input combinations may include each a same number of inputs or a different number of inputs. For example, when there are four inputs, each of the input combinations may include three inputs. Alternately or additionally, some of the input combinations may include two inputs and others may include three inputs.

In some embodiments, for each input combination, the device 110 may follow the procedures above. For example, for each combination, the device 110 may select a unique key pair of the first encryption algorithm. Thus multiple different key pairs may be selected. In these and other embodiments, the plaintext or each shard of the plaintext may be encrypted using each of the public keys of the multiple key pairs.

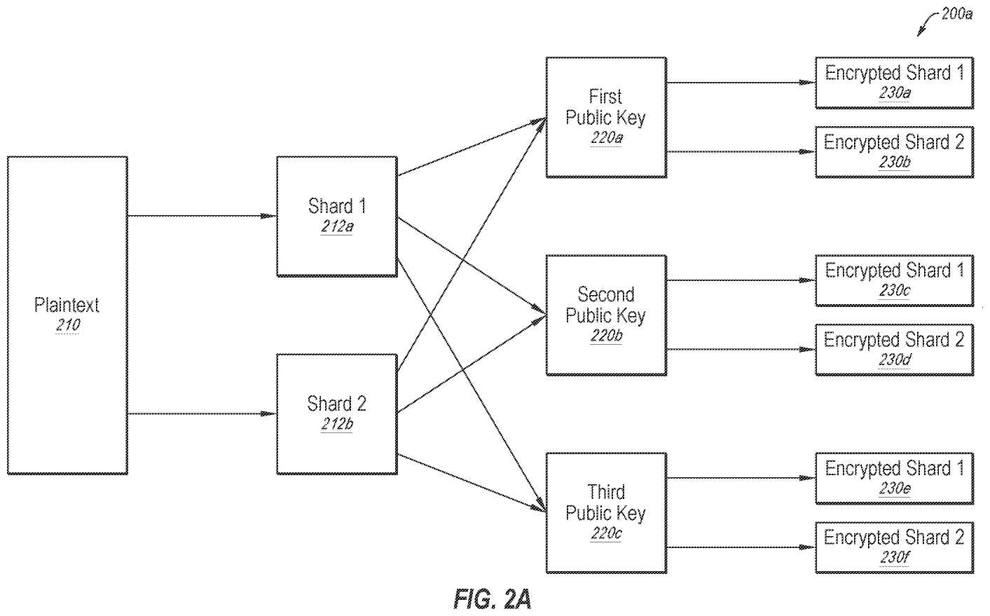

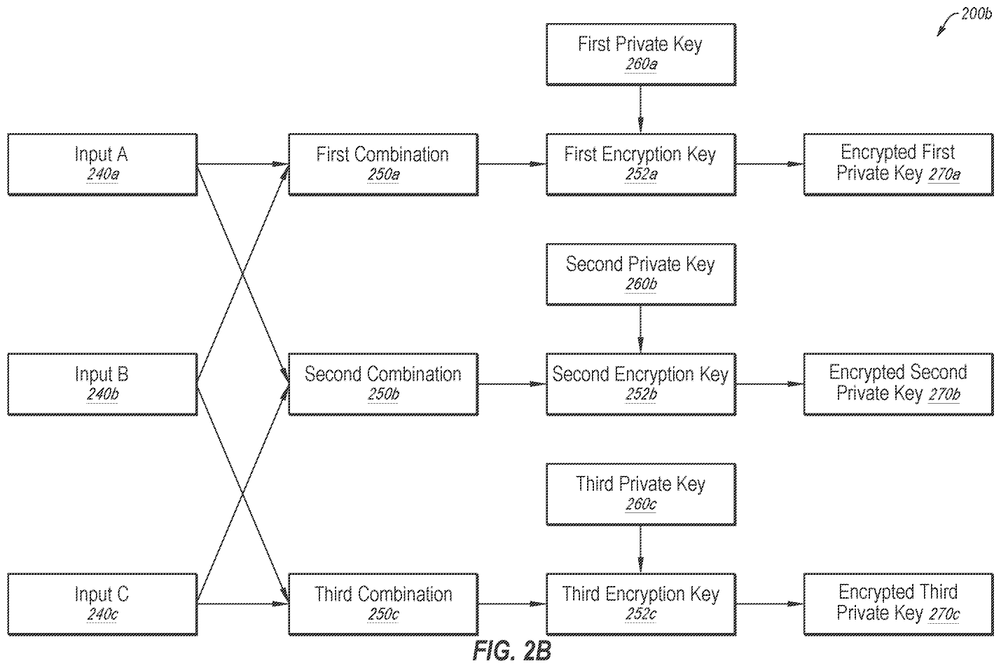

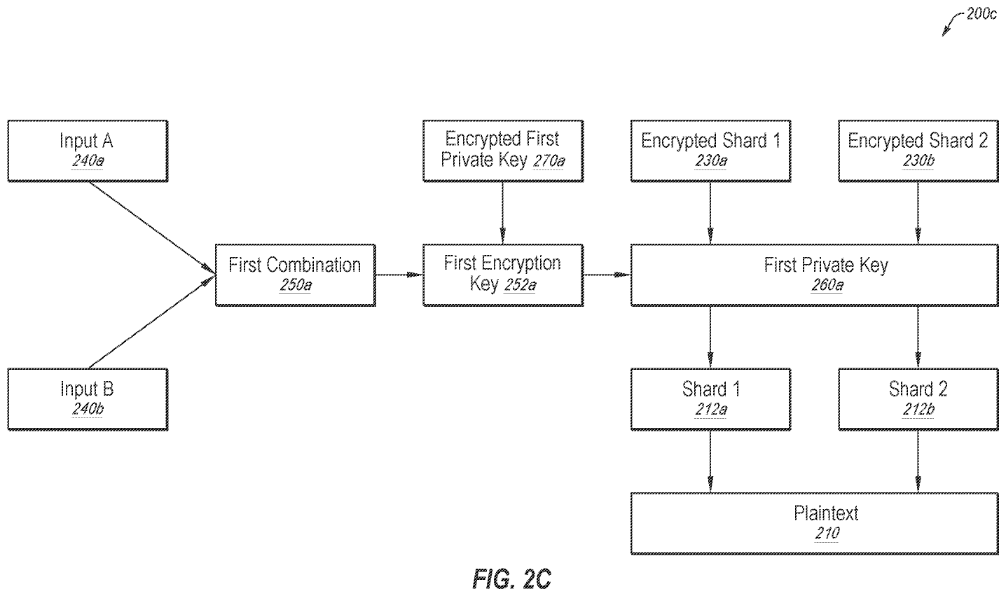

As an example, FIG. 2a illustrates example operations 200a for plaintext encryption, according to one or more embodiments of the disclosure. The operations 200a include obtain plaintext 210. The plaintext 210 may be divided into a first shard 212a and a second shard 212b, referred to collectively as the shards 212. In these and other embodiments, three combinations of inputs may be used to secure the plaintext 210. As such, three different key-pairs of the first encryption algorithm may be used to secure the plaintext 210. The three key-pairs may each include a public key, including a first public key 220a, a second public key 220b, a third public key 220c, referred to collectively as the public keys 220. In these and other embodiments, each of the shards 212 may be encrypted using each of the public keys 220. For example, each of the shards 212 may be encrypted using the first public key 220a to generate a first encrypted shard 230a and a second encrypted shard 230b. Each of the shards 212 may also be encrypted using the second public key 220b to generate a third encrypted shard 230c and a fourth encrypted shard 230d. And each of the shards 212 may also be encrypted using the third public key 220c to generate a fifth encrypted shard 230e and a sixth encrypted shard 230f. In these and other embodiments, the first encrypted shard 230a, the third encrypted shard 230c, and the fifth encrypted shard 230e may be a ciphertext of the first shard 212a and the second encrypted shard 230b, the fourth encrypted shard 230d, and the sixth encrypted shard 230f may be a ciphertext of the second shard 212b.

Returning to the discussion of FIG. 1, the device 110 may also generate a key for the second encryption algorithm using each of the input combinations such that multiple different keys are generated. In these and other embodiments, each of the private keys may be encrypted using one of the multiple different keys using the second encryption algorithm.

As an example, FIG. 2b illustrates example operations 200b for private key encryption, according to one or more embodiments of the disclosure. The example operations 200b include obtaining an input A 240a, an input B 240b, and an input C 240c, referred to collectively as the inputs 240. The inputs 240 may be obtained from a user. The inputs 240 may be used to generate a first combination 250a, a second combination 250b, and a third combination 250c, referred to collectively as the combinations 250. Each of the combinations 250 may include two of the inputs 240. For example, the first combination 250a may include the input A 240a and the input B 240b; the second combination 250b may include the input A 240a and the input C 240c; and the third combination 250c may include the input B 240b and the input C 240c.

The first combination 250a may be used to generate a first encryption key 252a. For example, a hash may be generated of the first combination 250a of any particular length that may be used to generate the first encryption key 252a. The second combination 250b may be used to generate a second encryption key 252b. The third combination 250c may be used to generate a third encryption key 252c.

The first encryption key 252a may be used to encrypt a first private key 260a that is part of the key pair with the first public key 220a to generate an encrypted first private key 270a. The second encryption key 252b may be used to encrypt a second private key 260b that is part of the key pair with the second public key 220b to generate an encrypted second private key 270b. The third encryption key 252c may be used to encrypt a third private key 260c that is part of the key pair with the third public key 220c to generate an encrypted third private key 270c.

Returning to the discussion of FIG. 1, in some embodiments, after encryption of the plaintext and encryption of the private keys, the device 110 may direct the ciphertexts and the encrypted private keys to one or both of the first system 120 and the second system 130. Alternately or additionally, the device 110 may send some of the ciphertexts to one of the first system 120 and the second system 130 and other of the ciphertexts to the other one of the first system 120 and the second system 130. Alternately or additionally, the device 110 may maintain some or all of the ciphertexts and the encrypted private keys at the device.

In some embodiments, in response to a request to obtain the plaintext, the device 110 may present a request to a user to obtain the one or more inputs used to generate the keys for the second encryption algorithm. For example, the device 110 may present questions and/or requests and obtain responses from the user as the inputs. For example, the responses may be text, images, sounds, or other inputs. The device 110 may use one combination of the inputs to generate a key to decrypt the encrypted private key corresponding to the one combination. After decrypting the encrypted private key, the private key may be used to decrypt the ciphertexts encrypted with the public key corresponding to the decrypted private key to obtain the plaintext. In these and other embodiments, when there are multiple ciphertexts from the encryption of multiple shards of the plaintext, after decrypting the shards, the shards may be combined to generate the plaintext.

As an example, FIG. 2c illustrates example operations 200c for plaintext decryption, according to one or more embodiments of the disclosure. The operations 200c may include obtaining the input A 240a and the input B 240b. The input A 240a and the input B 240b may be obtained from a user. The input A 240a and the input B 240b may be used to form the first combination 250a. The first combination 250a may be used to generate the first encryption key 252a. The first encryption key 252a may be used to decrypt the encrypted first private key 270a to obtain the first private key 260a. The first private key 260a may decrypt the first encrypted shard 230a and the second encrypted shard 230b that were encrypted using the first public key 220a that is part of the key pair with the first private key 260a. The decryption of the first encrypted shard 230a and the second encrypted shard 230b may produce the first shard 212a and the second shard 212b. The first shard 212a and the second shard 212b may be combined to generate the plaintext 210.

In some embodiments, as described previously, the device 110 may generate an identifier, e.g., a checksum, for each of the keys for the second encryption scheme. In these and other embodiments, after generating an encrypted private key, the device 110 may associate the identifier of the key used to encrypt the encrypted private key with the encrypted private key. As a result, the device 110 may use the identifier to identify the encrypted private key from among multiple encrypted private keys and use a key associated with the identifier to decrypt the identified encrypted private key. For example, a first key with an identifier may be used to encrypt a first private key. The identifier may be associated with the encrypted first private key. When attempting to identify an encrypted private key to decrypt after obtaining the first key from a combination of inputs, the device 110 may use the identifier generated from the first key to identify the encrypted first private key from among multiple encrypted private keys and use the first key to decrypt the encrypted first private key.

As discussed previously, the device 110 may send the encrypted private keys to one or more of the first system 120 and the second system 130. In these and other embodiments, the device 110 may send an identifier to one or more of the first system 120 and the second system 130 to allow the one or more of the first system 120 and the second system 130 to use the identifier to identify the proper encrypted private key to send back to the device 110. Alternately or additionally, the one or more of the first system 120 and the second system 130 may send all of the encrypted private keys back to the device 110 and the device 110 may use the identifier to determine the proper encrypted key to decrypt.

In some embodiments, the device 110 may also associate an identifier associated with a key of the second encryption scheme with each of the ciphertexts. For example, a key of the second encryption scheme may be based on a hash that includes a checksum value that may be used as the identifier. The key may be used to encrypt a private key of the first encryption scheme. The identifier may be associated with the ciphertexts encrypted using the public key corresponding to the private key encrypted using the key of the second encryption scheme from which the identifier is derived. Using the association, the device 110 may identify the ciphertext to decrypt with the private key. Alternately or additionally, the device 110 may use the decrypted private key to determine the ciphertext to decrypt using the private key.

As discussed previously, the device 110 may send the ciphertext to one or more of the first system 120 and the second system 130. In some embodiments, the device 110 may send multiple ciphertexts based on using multiple combinations to secure the plaintext as previously described. In these and other embodiments, the device 110 may provide the identifier with the ciphertexts to one or more of the first system 120 and the second system 130. As a result, when the device 110 request ciphertexts, the device 110 may provide the identifier to allow the one or more of the first system 120 and the second system 130 to identify the proper ciphertext to send to the device 110.

In some embodiments, the device 110 may also send the public keys to the one or more of the first system 120 and the second system 130. In these and other embodiments, the one or more of the first system 120 and the second system 130 may verify an identity of the device 110 using the public keys before corresponding with the device 110. For example, the device 110 may request ciphertexts from one or more of the first system 120 and the second system 130. In response the one or more of the first system 120 and the second system 130 may send a message based on the public key requesting a signature from the device 110 using the private key. The device 110 may sign the message using the private key and respond to the request. In response to receiving the signed message, the one or more of the first system 120 and the second system 130 may provide the ciphertext to the device 110.

In some embodiments, in response to receiving a signed message from the device 110, one or more of the first system 120 and the second system 130 may initiate a secondary validation procedure. In the secondary validation procedure, the one or more of the first system 120 and the second system 130 may send confirmation messages to one or more secondary accounts 140. The secondary accounts 140 may be accounts identified by the device 110 as being associated with the device 110 or a user of the device 110. For example, the secondary accounts 140 may be email, social media, or the accounts of the user and/or people associated with the user. The one or more of the first system 120 and the second system 130 may validate the request from the device 110 in response to a threshold number of the secondary accounts 140 confirming that the device 110 may receive the ciphertext. In these and other embodiments, the threshold number may be any percentage between 1 and 100 of the total confirmation messages provided.

Modifications, additions, or omissions may be made to the environment 100 without departing from the scope of the present disclosure. For example, in some embodiments, the environment 100 may not include the secondary accounts 140. Alternately or additionally, the environment 100 may not include the first system 120 and/or the second system 130. In these and other embodiments, the device 110 may store some or all of the encrypted private keys and/or ciphertexts.

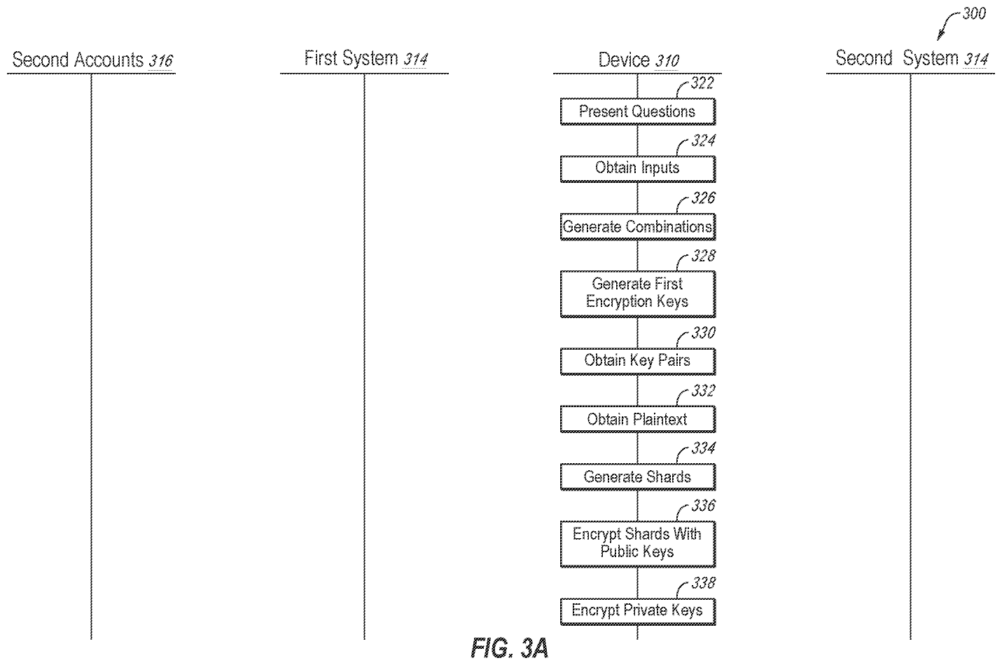

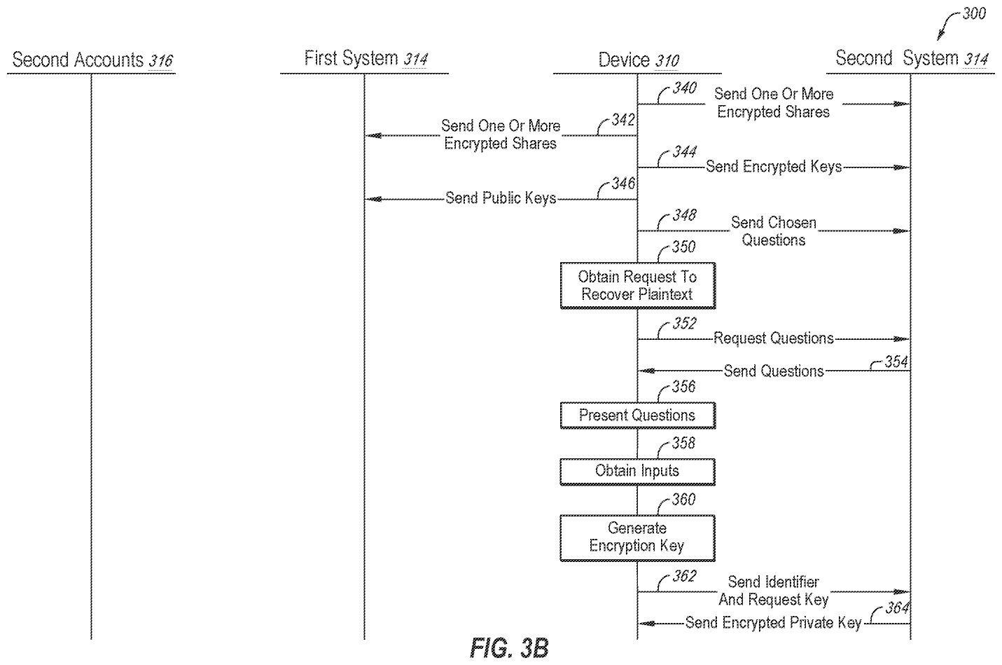

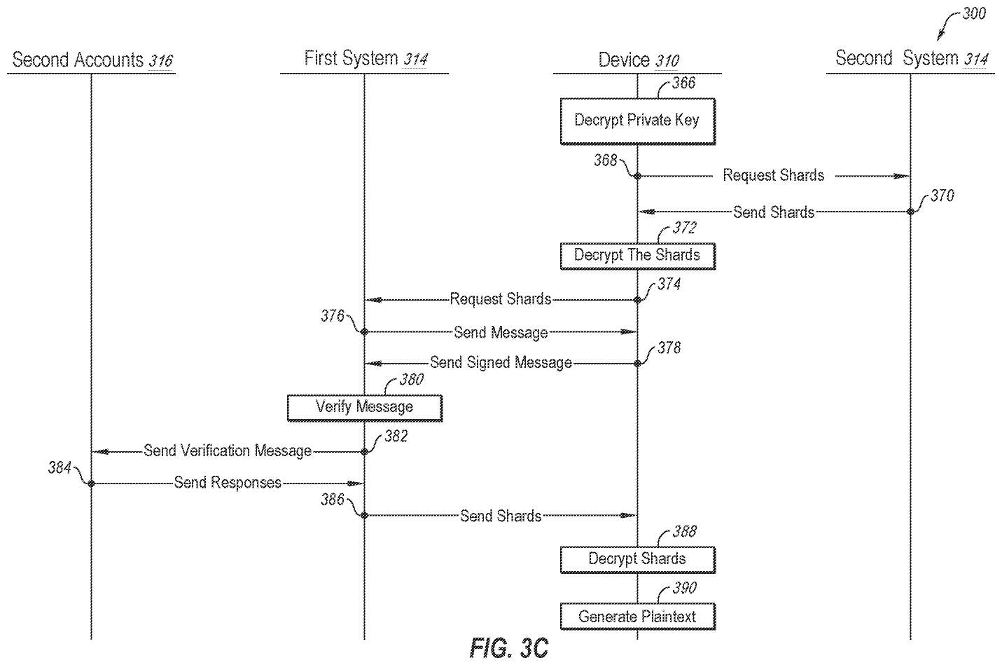

FIGS. 3a, 3b, and 3c illustrate other example operations to secure data. The operations 300 may be arranged in accordance with at least one embodiment described in the present disclosure. The operations 300 may be performed by or including communications between a device 310, a first system 312, a second system 314, and one or more secondary accounts 316.

In some embodiments, the device 310, the first system 312, the second system 314, and the one or more secondary accounts 316 may be analogous to the device 110, the first system 120, the second system 130, and the secondary accounts 140 of FIG. 1, respectively. Accordingly, no further explanation is provided with respect thereto.

In some embodiments, the operations 300 may be an example of operations of and communications and interactions between the device 310, the first system 312, the second system 314, and the one or more secondary accounts 316. Generally, the operations 300 may relate to securing data. The interactions between the device 310, the first system 312, the second system 314, and the one or more secondary accounts 316 may occur over one or more networks. The operations 300 illustrated are not exhaustive but are merely representative of operations 300 that may occur. Furthermore, one operation as illustrated may represent one or more communications, operations, and/or data exchanges.

In some embodiments, the operations 300 may occur in the following example context. The context is merely an example context where the operations 300 may occur and is not limiting. In the example, the device 310 may be a device of a user operating an application. The application may be configured to generate a cryptocurrency wallet. The cryptocurrency wallet may be configured to store one or more cryptocurrencies. In this example, the operations performed by the device 310 may be performed by the application running on the device 310. The first system 312 may be a system that supports and is associated with the application. For example, the first system 312 may be a backend system that saves information for the application and/or provides data to the application. In these and other embodiments, the operations performed by the application may include sending one or more requests to an application programming interface (API) of the first system 312.

In this example, the second system 314 may be a cloud storage system linked with the device 310. The cloud storage system may be a secured cloud storage system operated by a third-party that the device 310 may be configured to access. In these and other embodiments, the application may interface directly with the cloud storage system directly or a user may assist in performing operations between the cloud storage system and the application. For example, when sending information to the cloud storage system, the application may perform this automatically or request the user to assist in sending information to the cloud storage system.

Furthermore, in this example, the secondary accounts 316 may be one or more accounts that may be identified by the user for a secondary verification process when the user begins using the services provided by the application.

At operation 322, the device 310 may begin running the application associated with the first system 312. The application may begin a process of cryptocurrency wallet creation. During the process of cryptocurrency wallet creation, the device 310 may present multiple questions and/or requests to a user of the device 310. The questions may include specific answers that may be generally unique to the user, such as a user's favorite food, first pet's name, favorite animal, favorite vacation destination, among other questions. As another example, the questions may be directed to obtain sounds and/or images. For example, the question may include singing or playing the favorite phrase from a song. The image may be a favorite picture or meme. Alternately or additionally, the image may be a biometric identifier, such as a face image, iris image, or fingerprint image. In some embodiments, the user may be directed to answer all or a subset of the questions and/or requests.

At operation 324, the device 310 may obtain answers to all or some of the questions and/or requests. The answers may be considered as inputs to the application. The device 310 may store the questions and/or requests to which answers were provided.

At operation 326, the device 310 may generate combinations of the inputs. In these and other embodiments, the device 310 may generate combinations using all of the inputs or only a subset of the inputs. For example, if five inputs are provided and each combination includes three of the five inputs, the device 310 may generate ten unique combinations of inputs where the order of the inputs is not considered. In some embodiments, the number of inputs in each combination may be selected by the user. Alternately or additionally, the number of inputs in each combination may be selected based on information stored in the application or on information obtained about the user.

At operation 328, the device 310 may generate encryption keys for each of the combinations generated in operation 326 using the combinations. For example, for each combination, the device 310 may generate a unique hash of the combination that may be an encryption key. In these and other embodiments, the device 310 may further generate an identifier for each of the encryption keys. The identifiers may be checksums of the encryption keys. The encryption keys may be used for a first encryption algorithm. For example, the first encryption algorithm may be AES.

At operation 330, the device 310 may obtain key pairs of a second encryption algorithm that is different than the first encryption algorithm. For example, the second encryption algorithm may be RSA. Unique key pairs may be obtained for each combination of inputs generated in operation 326. Each key pair may include a private key and a corresponding public key.

At operation 332, the device 310 may obtain plaintext to be encrypted. In some embodiments, the plaintext may be a mnemonic phrase that may be used to form the cryptocurrency wallet. In these and other embodiments, the device 310 may generate the mnemonic phrase. Alternately or additionally, the device 310 may obtain the mnemonic phrase from another device, such as the first system 312.

At operation 334, the device 310 may generate shards of the plaintext to be encrypted. The shards may be generated by dividing the plaintext. In these and other embodiments, the plaintext may be divided such that the plaintext may be reconstructed only using all of the shards. Alternately or additionally, the plaintext may be divided such that the plaintext may be reconstructed using a particular threshold number of the shards.

At operation 336, the device 310 may encrypt all of the shards using each of the public keys from the key pairs obtained in operation 320. For example, if there are four shards and five public keys, when each of the four shards may be encrypted using each of the five public keys such that twenty encrypted shards are generated.

At operation 338, the device 310 may encrypt each of the private keys of the key pairs with a different one of the encryption keys generated in operation 328. In these and other embodiments, the encrypted key pairs may be associated with the identifiers of the encryption keys so that the encryption key used to encrypt a particular one of the private keys may be identified in future operations.

At operation 340, the device 310 may send one or more of the encrypted shards to the second system 314. In these and other embodiments, the device 310 may send all but one of the encrypted shards to the second system 314. Alternately or additionally, the device 310 may send one fewer encrypted shard to the second system 314 than may be used to construct the plaintext. As a result, in these and other embodiments, the second system 314 may obtain encrypted shards but not enough encrypted shards that the plaintext may be reconstructed even if all of the shards at the second system 314 were decrypted.

At operation 342, the device 310 may send one or more of the encrypted shards to the first system 312. In these and other embodiments, the device 310 may send all but one of the encrypted shards to the first system 312. Alternately or additionally, the device 310 may send one fewer encrypted shard to the first system 312 than may be used to construct the plaintext. As a result, in these and other embodiments, the first system 312 may obtain encrypted shards but not enough encrypted shards that the plaintext may be reconstructed even if all of the shards at the first system 312 were decrypted.

At operation 344, the device 310 may send one or more of the encrypted key pairs to the second system 314. In these and other embodiments, the device 310 may also send the identifier associated with each of the encrypted key pairs to the second system 314 to allow the second system 314 to identify the encrypted key pairs based on the identifier.

At operation 346, the device 310 may send the public keys associated with each of the encrypted shards sent to the first system 312. In these and other embodiments, the public keys may be embedded or otherwise associated with the shards which the public key encrypted. In these and other embodiments, the public keys may have been sent with the encrypted shards such that this operation occurs with the operation 344.

At operation 348, the device 310 may send the questions and/or requests to which answers were provided to the second system 314. As a result, the device 310 may not store any information that may be used by the device 310 to obtain the plaintext even though the device 310 may include the application with the instructions that may be used to obtain the plaintext. Thus, the plaintext may not be obtainable without permission of the user unless each of the device 310, the second system 314, and the first system 312 is compromised. As a result, the security of the plaintext may be enhanced.

The operations may describe a method that may be used to secure plaintext obtained by the device 310. For example, the operations may describe how the plaintext may be encrypted and how the components used to decrypt the plaintext may be distributed between multiple systems. Operation 350 and further operations may describe how to decrypt the plaintext after encryption. Thus, some amount of time may occur between operation 348 and operation 350, such as an hour, day, week, month, decade, century, or some other amount of time.

At operation 350, the device 310 may obtain a request to recover the plaintext obtained and encrypted as described previously by the application on the device 310.

At operation 352, the device 310 may request the questions and/or requests from the second system 314. In these and other embodiments, the device 310 may establish a secure connection with the second system 314 and be verified as an authorized device before requesting the questions and/or requests from the second system 314.

At operation 354, the second system 314 may provide the questions and/or requests to the device 310. The questions and/or requests may be the questions and/or requests to which the user provided answers in operation 324.

At operation 356, the device 310 may present the questions and/or requests obtained from the second system 314 to the user of the device 310. At operation 358, the device 310 may obtain answers to all or some of the questions and/or requests. The answers may be considered as inputs to the application. The device 310 may generate a combination using the answers obtained. In some embodiments, the device 310 may obtain answers to some of the questions and/or requests. In these and other embodiments, the device 310 may obtain a number of answers that at least equals the number of inputs in each combination as generated in operation 326. For example, when the device 310 obtains five answers in operation 324 and generated combinations with three of the five answers, the device 310 may obtain three answers during operation 356. Note that the device 310 may obtain any three-answer combination of the five answers obtained during the operation 356 because similar procedures were performed for each of the three answer combinations. By only using three of the answers, if the user cannot remember the answers provided for two of the questions and/or requests, the user may still be able to obtain the plaintext.

At operation 360, the device 310 may generate an encryption key using the combination generated in operation 358. The device 310 may also generate an identifier of the encryption key.

At operation 362, the device 310 may send the identifier and a request for the encrypted private key associated with the identifier to the second system 314.

At operation 364, the second system 314 may identify the encrypted private key using the identifier and send the encrypted private key to the device 310. In some embodiments, the second system 314 may not identify an encrypted private key because the identifier sent from the device 310 may not match any identifiers of the encrypted private keys at the second system 314. Not identifying an encrypted private key may result from one or more incorrect answers being provided by the user. Note that the device 310 may not be able to identify if a user entered an incorrect answer based merely on the answers themselves because the device 310 may not store the answers or combinations of the answers. Rather, after generating the encryption keys using the combinations, the answers and combinations may be deleted to further secure the plaintext.

In response to an incorrect answer being obtained, the encryption key generated in 360 may be different than any encryption key generated in operation 328. As a result, the identifier, e.g., the checksum of the encryption key generated in operation 360 may be different than an identifier of any of the encryption keys generated in operation 328. In these and other embodiments, in response to not identifying an encrypted private key associated with the identifier, the second system 314 may provide a message to the device 310 indicating that no encrypted private key is found. In response to obtaining the message of no encrypted private key being found, the device 310 may indicate to the user that one or more incorrect answers were provided. Alternately or additionally, in response to an incorrect answer being provided, the device 310 may cause a time delay before additional answers may be provided or initiate additional security procedures before allowing the user to enter other answers.

At operation 366, the device 310 may decrypt the encrypted private key using the encryption key generated in operation 360.

At operation 368, the device 310 may send a request to the second system 314 to provide the shards encrypted using the decrypted private key.

At operation 370, the second system 314 may identify the shards encrypted using the decrypted private key and send the encrypted shards to the device 310. In these and other embodiments, the device 310 may provide the decrypted private key to the second system 314 to assist the second system 314 to identify the encrypted shards. Alternately or additionally, the second system 314 may provide all of the shards stored at the second system 314 and allow the device 310 to identify the shards encrypted using the decrypted private key.

At operation 372, the device 310 may decrypt the shards using the decrypted private key. Note that after decrypting the shards, the device 310 may be unable to obtain the plaintext because the shards stored by the second system 314 may not include sufficient information to reconstruct the plaintext without the shards from the first system 312.

At operation 374, the device 310 may send a request to the first system 312 for the shards stored by the first system 312.

At operation 376, in response to the request from the device 310, the first system 312 may send a message to the device 310 for signature by the device 310 using the decrypted private key. In these and other embodiments, the first system 312 may generate the message using a public key obtained from the device 310 in operation 346. In these and other embodiments, the first system 312 may not have information regarding which public key held by the first system 312 corresponds to the private key decrypted by the device 310. In these and other embodiments, the first system 312 may provide multiple messages to the device 310 where each message is constructed using one of the public keys. Alternately or additionally, the device 310 may provide an identifier associated with the decrypted private key to allow the first system 312 to identify the public key corresponding to the decrypted private key.

At operation 378, the device 310 may sign the message obtained from the first system 312 using the decrypted private key.

At operation 380, the first system 312 may verify that the signature obtained from the device 310 is accurate. Accurately signing the message using the decrypted private key may indicate to the first system 312 that a user of the device 310 has accurately entered answers to the questions and/or requests to obtain a private key that matches the public keys obtained by the first system 312 at operation 346 and that the user is seeking to decrypt the plaintext.

At operation 382, in response to verifying the message, the first system 312 may send one or more verification messages to one or more of the secondary accounts 316. At operation 384, the secondary accounts 316 may provide responses to the first system 312. As an example, the verification process may include sending a request to one or more of the secondary accounts 316 to send a verification that the owner of the cryptocurrency wallet is attempting to recover the plaintext.

At operation 386, in response to the responses to the first system 312 being verified, the first system 312 may provide the encrypted shards stored by the first system 312 to the device 310. In response to the responses not being verified by the first system 312, the first system 312 may not provide the shards stored at the first system 312 to the device 310. As a result, the device 310 may not be able to reconstruct the plaintext. At operation 388, the device 310 may decrypt the encrypted shards from the first system 312 using the decrypted private key.

At operation 390, the device 310 may construct the plaintext using the shards from the first system 312 and the shards from the second system 314 to obtain the plaintext. In response to the plaintext being a mnemonic phrase used to create a cryptocurrency wallet, the plaintext may be used to create the cryptocurrency wallet previously created and access cryptocurrency assets stored in the wallet.

Modifications, additions, or omissions may be made to the operations 300 without departing from the scope of the present disclosure. For example, in some embodiments, the operations 300 may include one or more additional operations. For example, the operations 300 may include a waiting time period that may expire before the first system 312 may send the encrypted shards to the device 310 in operation 386. As another example, before presenting questions and/or request in operation 322 and/or 356, the device 310 may authenticate a user. The authentication of the user may be performed using biometric identifiers and/or other passwords.

As another example, in some embodiments, the operations 300 may be arranged in a different order. For example, the operations 342 and 346 may occur before the operation 340. As another example, one or more of the operations 332 and 334 may occur before operations 324, 326, 328, or 330. Alternatively or additionally, in some embodiments, one or more of the operations 300 may not be included. For example, the second system 314 may not be included. In these and other embodiments, the device 310 may store the data sent to the second system 314 at the device 310 or another device. As such, the operations 340, 344, 348, 352, 354, 362, 364, 368, and 370 between the device 310 and the second system 314 may not occur.

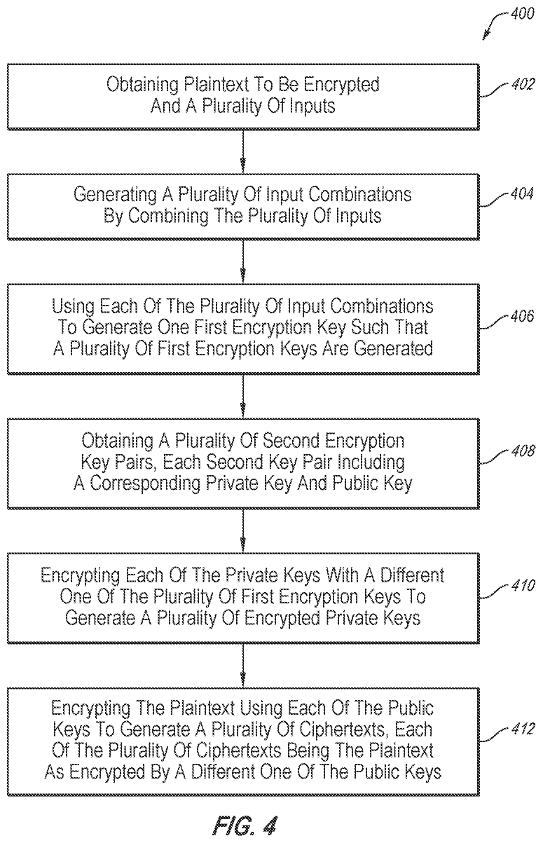

FIG. 4 illustrates a flowchart of an example method 400 of securing data. The method 400 may be arranged in accordance with at least one embodiment described in the present disclosure. One or more operations of the method 400 may be performed, in some embodiments, by a device or system, such as device 110 of FIG. 1 or another device, system, or combination of devices and systems. In these and other embodiments, the method 400 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 400 may begin at block 402, where plaintext to be encrypted and multiple inputs may be obtained.

At block 404, multiple input combinations may be generated by combining the multiple inputs. In some embodiments, a number of inputs of the multiple inputs in each of the multiple input combinations may be fewer than a total number of inputs in the multiple inputs. In these and other embodiments, each of the multiple input combinations may include a same number of the multiple inputs.

At block 406, each of the multiple input combinations may be used to generate one first encryption key such that multiple first encryption keys are generated.

At block 408, multiple second encryption key pairs may be obtained. In some embodiments, each second key pair may include a corresponding private key and public key. In these and other embodiments, the multiple first encryption keys may be associated with a first encryption algorithm and the multiple second encryption key pairs may be associated with a second encryption algorithm that is different than the first encryption algorithm.

At block 410, each of the private keys may be encrypted with a different one of the multiple first encryption keys to generate multiple encrypted private keys.

At block 412, the plaintext may be encrypted using each of the public keys to generate multiple ciphertexts. In some embodiments, each of the multiple ciphertexts may be the plaintext as encrypted by a different one of the public keys.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, the method 400 may further include directing one or more of the multiple ciphertexts over a data network to a server associated with the plaintext. As another example, the method 400 may further include splitting the plaintext into multiple plaintext shards. In these and other embodiments, encrypting the plaintext using each of the public keys may include encrypting each of the multiple plaintext shards using each of the public keys. Alternately or additionally, the method 400 may also include directing at least all of the multiple ciphertexts corresponding to one of the multiple plaintext shards over a network to a server such that the multiple ciphertexts corresponding to the one of the multiple plaintext shards are stored on a system separate from the multiple ciphertexts corresponding to another of the multiple plaintext shards.

As another example, the method 400 after encrypting the plaintext using each of the public keys to generate the multiple ciphertexts and encrypting each of the private keys with the different one of the multiple first encryption keys, that method 400 may further include obtaining second multiple inputs where the number of inputs is equal to the number of inputs from the multiple inputs in each of the multiple input combinations. The method 400 may also include generating a second input combination using the second multiple inputs and using the second input combination to generate a third encryption key. The method 400 may also include identifying one of the multiple encrypted private keys based on the third encryption key and decrypting the one of the multiple encrypted private keys using the third encryption key to generate a decrypted private key. The method 400 may also include identifying one of the multiple ciphertexts based on the decrypted private key and decrypting the one of the multiple ciphertexts using the decrypted private key to obtain the plaintext.

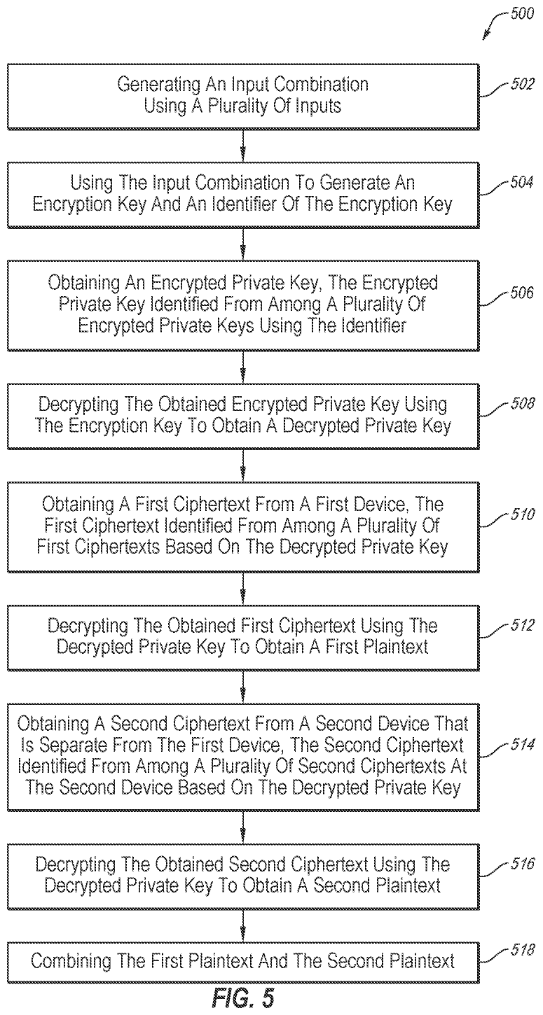

FIG. 5 illustrates a flowchart of an example method 500 of securing data. The method 500 may be arranged in accordance with at least one embodiment described in the present disclosure. One or more operations of the method 500 may be performed, in some embodiments, by a device or system, such as device 110 of FIG. 1 or another device, system, or combination of devices and systems. In these and other embodiments, the method 500 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 500 may begin at block 502, where an input combination may be generated using multiple inputs. At block 504, the input combination may be used to generate an encryption key and an identifier of the encryption key. At block 506, an encrypted private key may be obtained. In some embodiments, the encrypted private key may be identified from among multiple encrypted private keys using the identifier.

At block 508, the obtained encrypted private key may be decrypted using the encryption key to obtain a decrypted private key. In some embodiments, the encryption key may be associated with a first encryption algorithm and the private key may be associated with a second encryption algorithm that is different than the first encryption algorithm.

At block 510, a first ciphertext may be obtained from a first device. In some embodiments, the first ciphertext may be identified from among multiple first ciphertexts based on the decrypted private key. At block 512, the obtained first ciphertext may be decrypted using the decrypted private key to obtain a first plaintext.

At block 514, a second ciphertext may be obtained from a second device that is separate from the first device. In these and other embodiments, the second ciphertext may be identified from among multiple second ciphertexts at the second device based on the decrypted private key.

At block 516, the obtained second ciphertext may be decrypted using the decrypted private key to obtain a second plaintext. At block 518, the first plaintext and the second plaintext may be combined. In some embodiments, the method 500 is performed by the first device.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, the method 500 before generating the input combination using the multiple inputs may further include obtaining third plaintext to be encrypted. In some embodiments, the first plaintext and the second plaintext may be based on the third plaintext. The method 500 may further include obtaining multiple second inputs that include the multiple inputs and generating multiple second input combinations by combining the multiple second inputs, wherein the input combination is one of the multiple second input combinations. The method 500 may further include using each of the multiple second input combinations to generate one first encryption key such that multiple first encryption keys are generated. In these and other embodiments, the encryption key may be one of the multiple first encryption keys.

In these and other embodiments, the method 500 before generating the input combination using the multiple inputs may further include obtaining multiple second encryption key pairs. In these and other embodiments, each second key pair may include a corresponding private key and public key and one of the private keys may be the decrypted private key. The method 500 may further include encrypting each of multiple private keys with a different one of the multiple first encryption keys to generate the multiple encrypted private keys and splitting the third plaintext into the first plaintext and the second plaintext. The method 500 may further include encrypting the first plaintext using each of the public keys to generate the multiple first ciphertexts. In these and other embodiments, each of the multiple first ciphertexts may be the first plaintext as encrypted by a different one of the public keys. The method 500 may further include encrypting the second plaintext using each of the public keys to generate multiple second ciphertexts. In these and other embodiments, each of the multiple second ciphertexts may be the second plaintext as encrypted by a different one of the public keys.

In some embodiments, each of the multiple second input combinations may include a same number of the multiple second inputs. Alternately or additionally, a number of the multiple inputs is fewer than a number of the multiple second inputs.

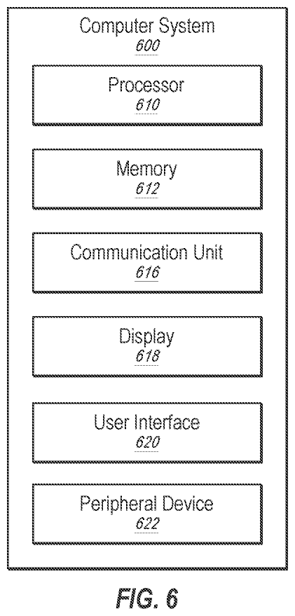

FIG. 6 illustrates an example system 600 that may be used during transcription presentation. The system 600 may be arranged in accordance with at least one embodiment described in the present disclosure. The system 600 may include a processor 610, memory 612, a communication unit 616, a display 618, a user interface unit 620, and a peripheral device 622, which all may be communicatively coupled. In some embodiments, the system 600 may be part of any of the systems or devices described in this disclosure.

For example, the system 600 may be part of the device 110 of FIG. 1 and may be configured to perform one or more of the tasks described above with respect to the device 110. As another example, the system 600 may be part of the first system 120 of FIG. 1 and may be configured to perform one or more of the tasks described above with respect to the first system 120.

Generally, the processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 610 may include any number of processors distributed across any number of networks or physical locations that are configured to perform individually or collectively any number of operations described herein. In some embodiments, the processor 610 may interpret and/or execute program instructions and/or process data stored in the memory 612. In some embodiments, the processor 610 may execute the program instructions stored in the memory 612.

For example, in some embodiments, the processor 610 may execute program instructions stored in the memory 612 that are related to transcription presentation such that the system 600 may perform or direct the performance of the operations associated therewith as directed by the instructions. In these and other embodiments, the instructions may be used to perform one or more of the operations 300 of FIG. 3 and/or operations of the method 400 or the method 500 of FIGS. 4 and 5.

The memory 612 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 610.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 610 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 616 may include any component, device, system, or combination thereof that is configured to transmit or receive information over a network. In some embodiments, the communication unit 616 may communicate with other devices at other locations, the same location, or even other components within the same system. For example, the communication unit 616 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication unit 616 may permit data to be exchanged with a network and/or any other devices or systems described in the present disclosure.

The display 618 may be configured as one or more displays, like an LCD, LED, Braille terminal, or other type of display. The display 618 may be configured to present video, text, user interfaces, and other data as directed by the processor 610. For example, when the system 600 is included in the device 110 of FIG. 1, the display 618 may be configured to present questions and/or requests to obtain inputs from a user.

The user interface unit 620 may include any device to allow a user to interface with the system 600. For example, the user interface unit 620 may include a mouse, a track pad, a keyboard, buttons, camera, and/or a touchscreen, among other devices. The user interface unit 620 may receive input from a user and provide the input to the processor 610. In some embodiments, the user interface unit 620 and the display 618 may be combined.

The peripheral devices 622 may include one or more devices. For example, the peripheral devices may include a microphone, an imager, and/or a speaker, among other peripheral devices.

Modifications, additions, or omissions may be made to the system 600 without departing from the scope of the present disclosure. For example, in some embodiments, the system 600 may include any number of other components that may not be explicitly illustrated or described. Further, depending on certain implementations, the system 600 may not include one or more of the components illustrated and described.

As indicated above, the embodiments described herein may include the use of a special purpose or general-purpose computer (e.g., the processor 610 of FIG. 6) including various computer hardware or software modules, as discussed in greater detail below. Further, as indicated above, embodiments described herein may be implemented using computer-readable media (e.g., the memory 612 of FIG. 6) for carrying or having computer-executable instructions or data structures stored thereon.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

We claim:

1. A method of securing data, the method comprising:
obtaining plaintext to be encrypted and a plurality of inputs;
generating a plurality of input combinations by combining the plurality of inputs;
using each of the plurality of input combinations to generate one first encryption key such that a plurality of first encryption keys are generated;
obtaining a plurality of second encryption key pairs, each second key pair including a corresponding private key and public key;
encrypting each of the private keys with a different one of the plurality of first encryption keys to generate a plurality of encrypted private keys; and
encrypting the plaintext using each of the public keys to generate a plurality of ciphertexts, each of the plurality of ciphertexts being the plaintext as encrypted by a different one of the public keys.

2. The method of claim 1, further comprising splitting the plaintext into a plurality of plaintext shards, wherein encrypting the plaintext using each of the public keys includes encrypting each of the plurality of plaintext shards using each of the public keys.

3. The method of claim 2, further comprising directing at least all of the plurality of ciphertexts corresponding to one of the plurality of plaintext shards over a network to a server such that the plurality of ciphertexts corresponding to the one of the plurality of plaintext shards are stored on a system separate from the plurality of ciphertexts corresponding to another of the plurality of plaintext shards.

4. The method of claim 1, wherein a number of inputs of the plurality of inputs in each of the plurality of input combinations is fewer than a total number of inputs in the plurality of inputs.

5. The method of claim 4, further comprising after encrypting the plaintext using each of the public keys to generate the plurality of ciphertexts and encrypting each of the private keys with the different one of the plurality of first encryption keys, performing the following:
obtaining a second plurality of inputs, the number of inputs is equal to the number of inputs from the plurality of inputs in each of the plurality of input combinations;
generating a second input combination using the second plurality of inputs;
using the second input combination to generate a third encryption key;
identifying one of the plurality of encrypted private keys based on the third encryption key;
decrypting the one of the plurality of encrypted private keys using the third encryption key to generate a decrypted private key;
identifying one of the plurality of ciphertexts based on the decrypted private key; and
decrypting the one of the plurality of ciphertexts using the decrypted private key to obtain the plaintext.

6. The method of claim 1, wherein each of the plurality of input combinations includes a same number of the plurality of inputs.

7. The method of claim 1, wherein the plurality of first encryption keys are associated with a first encryption algorithm and the plurality of second encryption key pairs are associated with a second encryption algorithm that is different than the first encryption algorithm.

8. The method of claim 1, further comprising directing one or more of the plurality of ciphertexts over a data network to a server associated with the plaintext.

9. At least one non-transitory computer-readable media configured to store one or more instructions that, in response to being executed by a system, cause or direct the system to perform the method of claim 1.

10. A system comprising:
one or more computer readable mediums including instructions;
one or more computing systems coupled to the one or more computer readable mediums and configured to execute the instructions to cause or direct the system to perform operations, the operations comprising:
obtaining plaintext to be encrypted and a plurality of inputs;
generating a plurality of input combinations using the plurality of inputs;
using each of the plurality of input combinations to generate one first encryption key such that a plurality of first encryption keys are generated;
obtaining a plurality of second encryption key pairs, each second key pair including a corresponding private key and public key;
encrypting each of the private keys with a different one of the plurality of first encryption keys to generate a plurality encrypted private keys; and
encrypting the plaintext using each of the public keys to generate a plurality of ciphertexts, each of the plurality of ciphertexts being the plaintext as encrypted by a different one of the public keys.

11. The system of claim 10, wherein the operations further comprise splitting the plaintext into a plurality of plaintext shards, wherein encrypting the plaintext using each of the public keys includes encrypting each of the plurality of plaintext shards using each of the public keys.

12. The system of claim 11, wherein the operations further comprise directing at least all of the plurality of ciphertexts corresponding to one of the plurality of plaintext shards over a network to a server such that the plurality of ciphertexts corresponding to the one of the plurality of plaintext shards are stored on a system separate from the plurality of ciphertexts corresponding to another of the plurality of plaintext shards.

13. A method of securing data, the method comprising:
generating an input combination using a plurality of inputs;
using the input combination to generate an encryption key and an identifier of the encryption key;
obtaining an encrypted private key, the encrypted private key identified from among a plurality of encrypted private keys using the identifier;
decrypting the obtained encrypted private key using the encryption key to obtain a decrypted private key;
obtaining a first ciphertext from a first device, the first ciphertext identified from among a plurality of first ciphertexts based on the decrypted private key;
decrypting the obtained first ciphertext using the decrypted private key to obtain a first plaintext;
obtaining a second ciphertext from a second device that is separate from the first device, the second ciphertext identified from among a plurality of second ciphertexts at the second device based on the decrypted private key;
decrypting the obtained second ciphertext using the decrypted private key to obtain a second plaintext; and
combining the first plaintext and the second plaintext.

14. The method of claim 13, wherein the method is performed by the first device.

15. The method of claim 13, wherein the encryption key is associated with a first encryption algorithm and the private key is associated with a second encryption algorithm that is different than the first encryption algorithm.

16. The method of claim 13, further comprising before generating the input combination using the plurality of inputs:
obtaining third plaintext to be encrypted, the first plaintext and the second plaintext based on the third plaintext;
obtaining a plurality of second inputs that include the plurality of inputs;
generating a plurality of second input combinations by combining the plurality of second inputs, wherein the input combination is one of the plurality of second input combinations; and
using each of the plurality of second input combinations to generate one first encryption key such that a plurality of first encryption keys are generated, wherein the encryption key is one of the plurality of first encryption keys.

17. The method of claim 16, further comprising before generating the input combination using the plurality of inputs:
obtaining a plurality of second encryption key pairs, each second key pair including a corresponding private key and public key and one of the private keys being the decrypted private key;
encrypting each of a plurality of private keys with a different one of the plurality of first encryption keys to generate the plurality of encrypted private keys;
splitting the third plaintext into the first plaintext and the second plaintext; and
encrypting the first plaintext using each of the public keys to generate the plurality of first ciphertexts, each of the plurality of first ciphertexts being the first plaintext as encrypted by a different one of the public keys; and
encrypting the second plaintext using each of the public keys to generate a plurality of second ciphertexts, each of the plurality of second ciphertexts being the second plaintext as encrypted by a different one of the public keys.

18. The method of claim 16, wherein each of the plurality of second input combinations includes a same number of the plurality of second inputs.

19. The method of claim 16, wherein a number of the plurality of inputs is fewer than a number of the plurality of second inputs.

20. At least one non-transitory computer-readable media configured to store one or more instructions that, in response to being executed by a system, cause or direct the system to perform the method of claim 13.
